(19) United States
(12) Patent Application Publication
(10) Pub. No.: US 2017/0019013 A1
(43) Pub. Date: Jan. 19, 2017

(54) ANIMAL TAIL-WAGGING SIMULATION DEVICE

(71) Applicant: Katzen Liebhaber Limited, Hong Kong (HK)

(72) Inventor: Ka Yu Chan, Hong Kong (HK)

(21) Appl. No.: 15/047,654

(22) Filed: Feb. 19, 2016

(30) Foreign Application Priority Data
Jul. 16, 2015 (CN) 201510419448.1

(51) Int. Cl. H02K 33/16; A63H 3/36; G04B 45/00

(52) U.S. Cl. CPC H02K 33/16; G04B 45/00; A63H 3/36

(57) ABSTRACT

An animal tail-wagging simulation device includes a housing, a circuit board mounted in the housing and provided with a driving coil, and a swinging arm pivotably coupled with the housing via a shaft. The swinging arm has an upper U-shaped portion. The driving coil is disposed in a middle of the U-shaped portion. Two sides of the U-shaped portion are provided respectively with two permanent magnets. When the driving coil is energized, electromagnetic field is generated and interacts with the permanent magnets to drive the swinging arm to swing. A swinging unit is provided at a lower end of the swinging arm. The swinging unit includes a swinging plate pivotably coupled with the swinging arm, and an adjustable counterweight.

### CROSS-REFERENCE TO RELATED APPLICATIONS

This application claims the benefit of Chinese patent application No. 201510419448.1 filed on Jul. 16, 2015, the entire content of which is hereby incorporated by reference.

### FIELD OF THE TECHNOLOGY

The present application relates to an animal tail-wagging simulation device.

### BACKGROUND

In some toys, clocks or other items, there may exit some animal tail-wagging simulation devices in order to make the toys more realistic, and the clocks more ornamental. Existing animal tail-wagging simulation devices are relatively stiff and not lively.

### SUMMARY

An object of the present application is to provide an animal tail-wagging simulation device in which the tail-wagging simulation effect is more lively.

According to one aspect, there is provided an animal tail-wagging simulation device which may include a housing; a circuit board mounted in the housing and provided with a driving coil; a swinging arm mounted in the housing, the swinging arm being provided with a U-shaped portion at an upper end thereof, the swinging arm being pivotably coupled with the housing through a first shaft, the position where the swinging arm is pivotably coupled with the housing is located below the U-shaped portion, the driving coil being disposed in a middle of the U-shaped portion, two sides of the U-shaped portion being provided respectively with two permanent magnets that associate with the driving coil, whereby when the driving coil is energized, electromagnetic field is generated and interacts with the permanent magnets to thereby drive the swinging arm to swing; and a first swinging unit provided at a lower end of the swinging arm, the first swinging unit including a first swinging plate pivotably coupled with the swinging arm through a second shaft and an adjustable first counterweight member provided at an upper end of the first swinging plate.

According to one embodiment of the animal tail-wagging simulation device of the present application, the first counterweight member includes one or more metal plates.

According to one embodiment of the animal tail-wagging simulation device of the present application, a second swinging unit may be provided at a lower end of the first swinging unit, the second swinging unit including a second swinging plate pivotably coupled with the first swinging plate through a third shaft, and an adjustable second counterweight member provided at an upper end of the second swinging plate.

According to one embodiment of the animal tail-wagging simulation device of the present application, the second counterweight member may include one or more metal plates.

According to one embodiment of the animal tail-wagging simulation device of the present application, the first counterweight member has a weight of 7.7˜7.75 g, and the second counterweight member has a weight of 1.3˜1.35 g.

According to one embodiment of the animal tail-wagging simulation device of the present application, a third swinging unit may be provided at a lower end of the second swinging unit, the third swinging unit including a third swinging plate pivotably coupled with the second swinging plate through a fourth shaft, and an adjustable third counterweight member provided at an upper end of the third swinging plate.

According to one embodiment of the animal tail-wagging simulation device of the present application, the third counterweight member may include one or more metal plates.

The animal tail-wagging simulation device of the present application has the following advantages. In the animal tail-wagging simulation device of the present application, the position where the swinging arm is pivotably coupled with the housing is located below the U-shaped portion, and the upper ends of the swinging plates are provided with adjustable counterweight members. This construction renders the center of gravity of the swinging arm and the swinging units to be situated in a suitable position such that when the animal tail swings, the entire animal tail-wagging simulation device is more lively.

### BRIEF DESCRIPTION OF THE DRAWINGS

Specific embodiments of the animal tail-wagging simulation device will now be described by way of example with reference to the accompanying drawings wherein:

FIG. 1 is a front schematic view of an embodiment of the animal tail-wagging simulation device of the present application;

FIG. 2 is a perspective schematic view of the animal tail-wagging simulation device shown in FIG. 1;

FIG. 3 is another perspective schematic view of the animal tail-wagging simulation device shown in FIG. 1;

FIG. 4 is an exploded schematic view of the animal tail-wagging simulation device shown in FIG. 1;

FIG. 5 is a perspective schematic view of the housing of the animal tail-wagging simulation device shown in FIG. 1;

FIG. 6 is a perspective schematic view of the circuit board of the animal tail-wagging simulation device shown in FIG. 1;

FIG. 7 is a perspective schematic view of the swinging arm of the animal tail-wagging simulation device shown in FIG. 1;

FIG. 8 is a perspective schematic view of the first swinging unit of the animal tail-wagging simulation device shown in FIG. 1;

FIG. 9 is a perspective schematic view of the second swinging unit of the animal tail-wagging simulation device shown in FIG. 1; and

FIG. 10 is an exploded schematic view of another embodiment of the animal tail-wagging simulation device of the present application.

### DETAILED DESCRIPTION

To have a clear understanding of the technical features, objects and effects of the animal tail-wagging simulation device of the present application, specific embodiments will now be described in detail with reference to the accompanying drawings.

Embodiments of the animal tail-wagging simulation device of the present application are described below in detail. These embodiments are shown in the accompanying drawings. Like reference numerals representing like parts are used throughout the drawings.

It should be appreciated that in the description of the animal tail-wagging simulation device of the present application, the terms “front”, “rear”, “top” and “bottom”, “upper end”, “lower end”, “upper portion”, “lower portion”, etc. refer to the orientation or position of a structure as it is oriented and positioned in the drawings. Those terms are used to simplify the description and do not indicate or imply that the structure must have a specific orientation or operate in a specific position. Those terms should not be considered as limiting. As used herein, the terms “first” and “second” etc. are merely used to differentiate features to be described, and are not meant to indicate or imply the relative importance of the features.

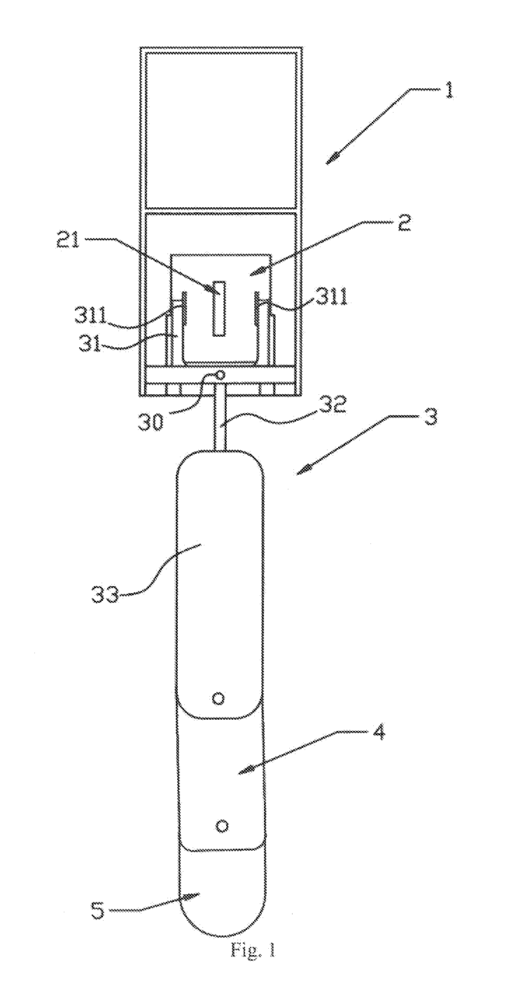

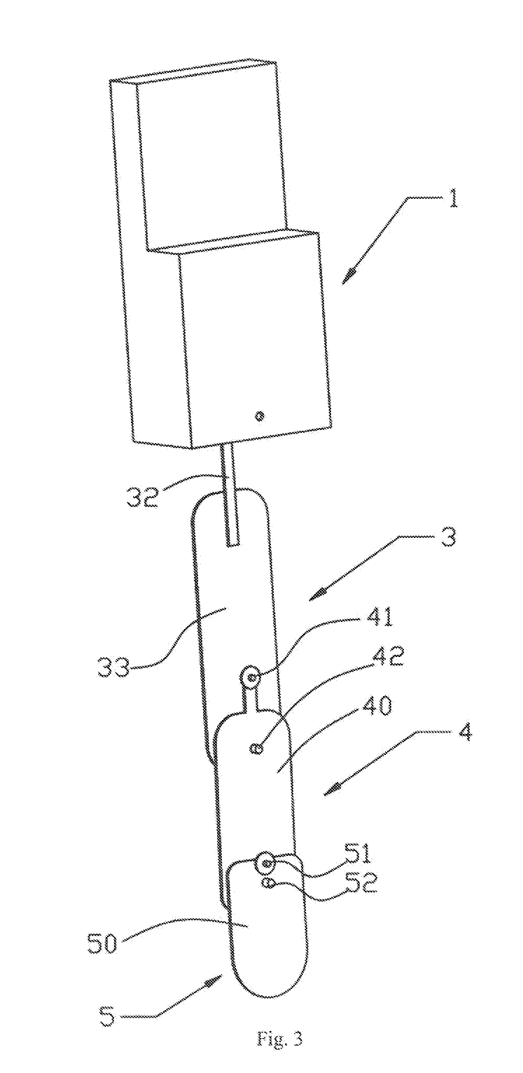

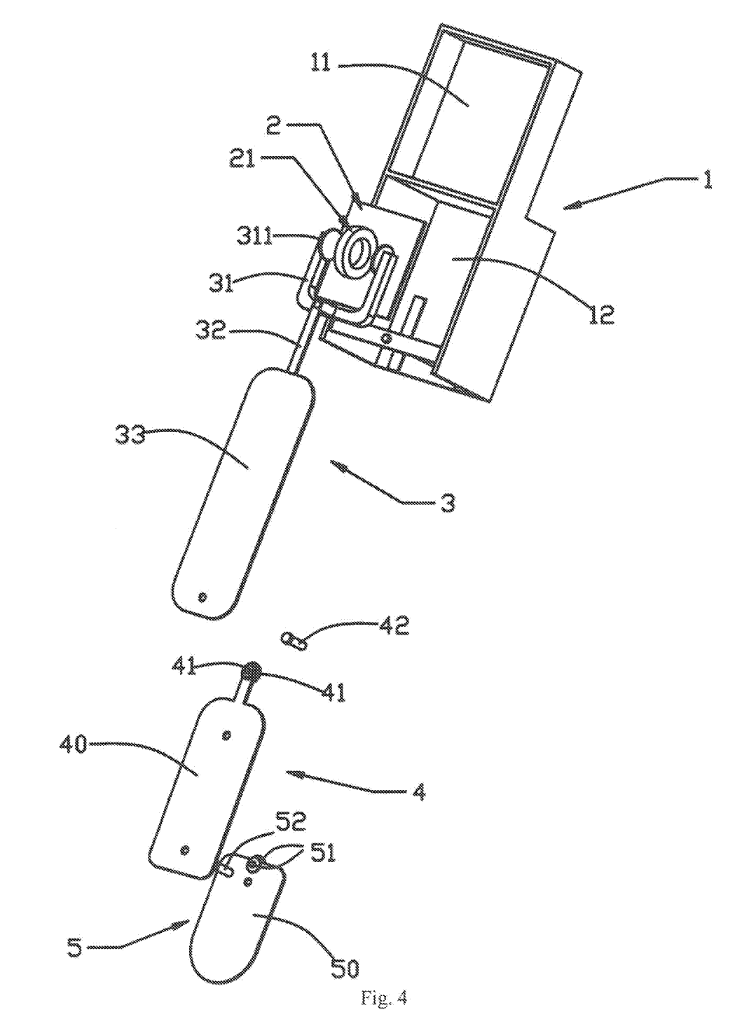

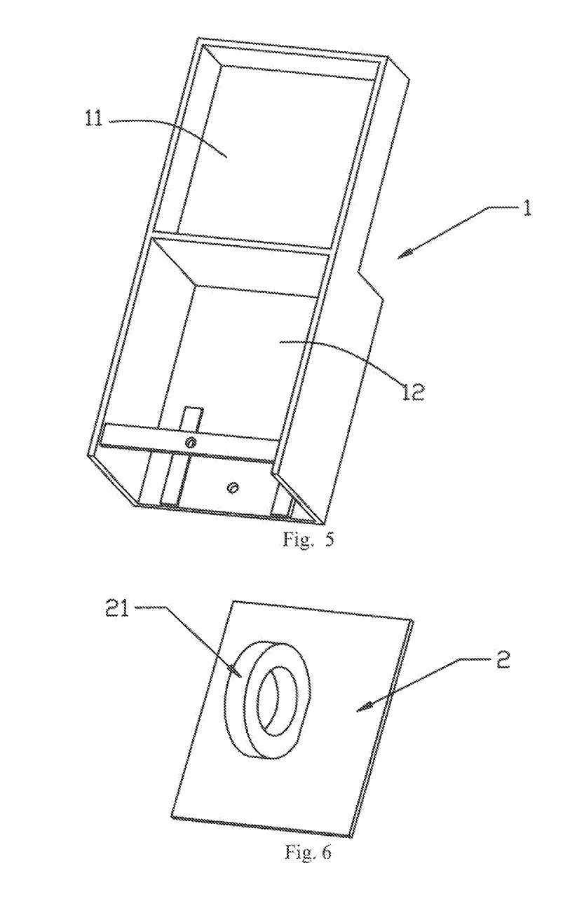

FIGS. 1-4 show an embodiment of the animal tail-wagging simulation device of the present application. The animal tail-wagging simulation device of the embodiment may be provided on a clock to simulate tail-wagging of an animal, especially tail-wagging of an animal having a long tail. The animal tail-wagging simulation device of the present embodiment may include a housing 1, a circuit board 2, a swinging arm 3, a first swinging unit 4, and a second swinging unit 5. The circuit board 2 may be mounted in the housing 1. The swinging arm 3 may be pivotably coupled with the housing 1. The first swinging unit 4 may be pivotably coupled with the swinging arm 3, and the second swinging unit 5 may be pivotably coupled with the first swinging unit 4. FIG. 5 is a perspective view of the housing 1. The housing 1 may be made of plastic, metal or any other suitable material. The housing 1 may be formed with a cavity 11 for accommodating a clock movement, and a second cavity 12 for receiving the circuit board 2. FIG. 6 is a perspective view of the circuit board 2. A driving coil 21 may be provided on the circuit board 2. The driving coil 21 may be an annular driving coil. When the driving coil 21 is energized, electromagnetic field can be generated. When the direction of the current changes, the direction of the generated electromagnetic field changes accordingly.

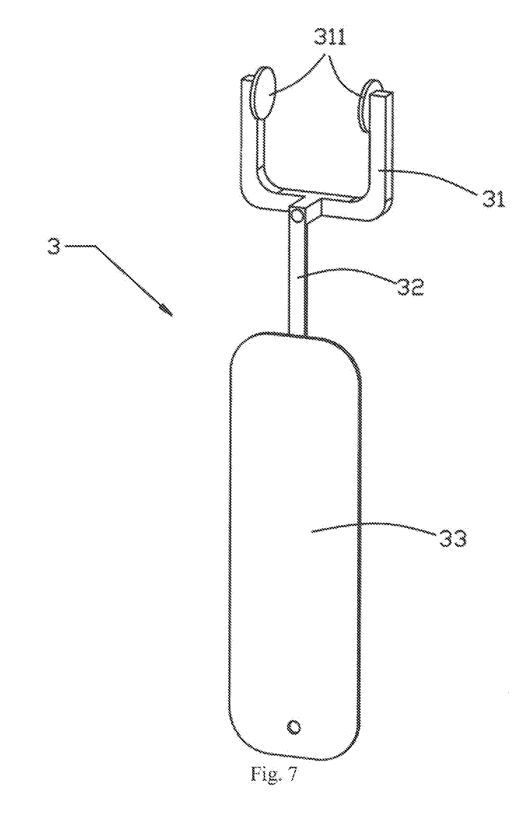

Referring to FIGS. 1-4 and 7, the swinging arm 3 may be provided with a U-shaped portion 31 at an upper end thereof. The swinging arm 3 may be pivotably coupled with the housing 1 through a first shaft 30. The position where the swinging arm 3 is pivotably coupled with the housing 1 can be located below the U-shaped portion 31. Since the position where the swinging arm 3 is pivotably coupled with the housing 1 is located below the U-shaped portion 31, the center of gravity of the swinging arm 3 can be located at a position closer the shaft 30 so that when the swinging arm 3 swings, the effect of resistance generated by its gravitational moment can be minimized. This can make the swinging more lively and save energy consumption of the driving coil 21. In the present embodiment, the swinging arm 3 may be formed of the upper U-shaped portion 31, a connecting arm 32 below the U-shaped portion 31, and a plate 33. Of course, the swinging arm 3 can be integrally formed. The driving coil 21 may be disposed in a middle of the U-shaped portion 31. Two sides of the U-shaped portion 31 may be provided respectively with two permanent magnets 311 that associate with the driving coil 21. When the driving coil 21 is energized, electromagnetic field is generated and interacts with the permanent magnets 311 to thereby drive the swinging arm 3 to swing. The permanent magnets 311 may be ferrite permanent magnets or alloy permanent magnets.

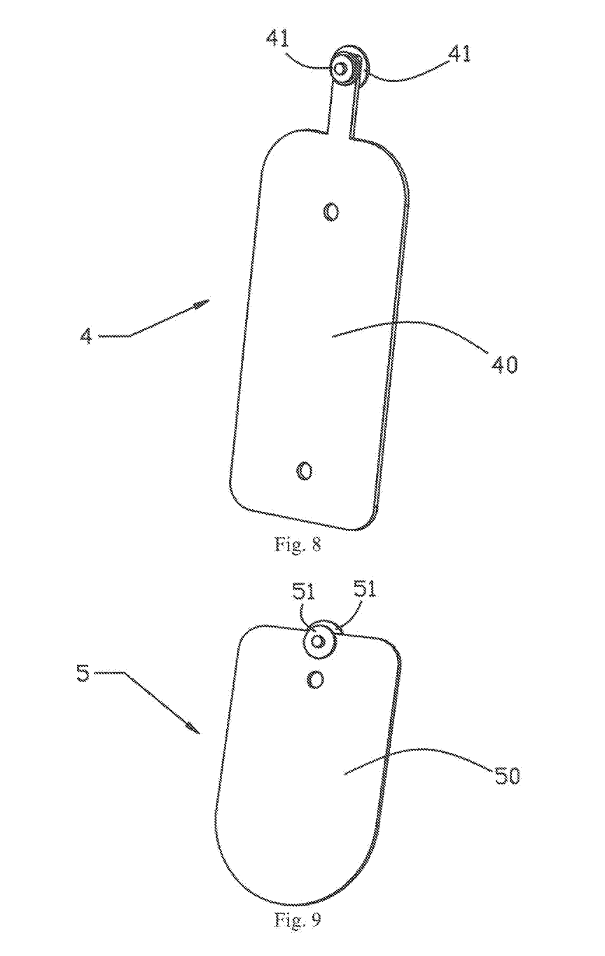

Referring to FIGS. 1-4 and 8, a first swinging unit 4 may be provided at a lower end of the swinging arm 3. The first swinging unit 4 may include a first swinging plate 40 pivotably coupled with the swinging arm 3 through a second shaft 42, and an adjustable first counterweight member 41 provided at an upper end of the first swinging plate 40. The first counterweight member 41 can be used to adjust the center of gravity of the first swinging unit 4 such that the center of gravity of the first swinging unit 4 can be closer to the position of the shaft 42. This can reduce the resistance generated by its gravitational moment when the first swinging unit 4 swings. The first counterweight member 41 may be in the form of one or more metal plates. The weight of the first counterweight member 41 can be adjusted by changing the number of the metal plates in order to achieve the effect of adjusting the center of gravity of the first swinging unit 4. The first counterweight member 41 may preferably have a weight of 7.7˜7.75 g. Of course, the weight of the first counterweight member 41 can be adjusted according to the specific condition of the first swinging unit 4.

Referring to FIGS. 1-4 and 9, a second swinging unit 5 may be provided at a lower end of the first swinging unit 4. The structure of the second swinging unit 5 can be the same as that of the first swinging unit 4. The second swinging unit 5 may include a second swinging plate 50 pivotably coupled with the first swinging plate 40 through a third shaft 52, and an adjustable second counterweight member 51 provided at an upper end of the second swinging plate 50. The second counterweight member 51 can be used to adjust the center of gravity of the second swinging unit 5 such that the center of gravity of the second swinging unit 5 can be closer to the position of the shaft 52. This can reduce the resistance generated by its gravitational moment when the second swinging unit 5 swings. The second counterweight member 51 may be in the form of one or more metal plates. The weight of the second counterweight member 51 can be adjusted by changing the number of the metal plates in order to achieve the effect of adjusting the center of gravity of the second swinging unit 5. The second counterweight member 51 may preferably have a weight of 1.3˜1.35 g. Of course, the weight of the second counterweight member 51 can be adjusted according to the specific condition of the second swinging unit 5.

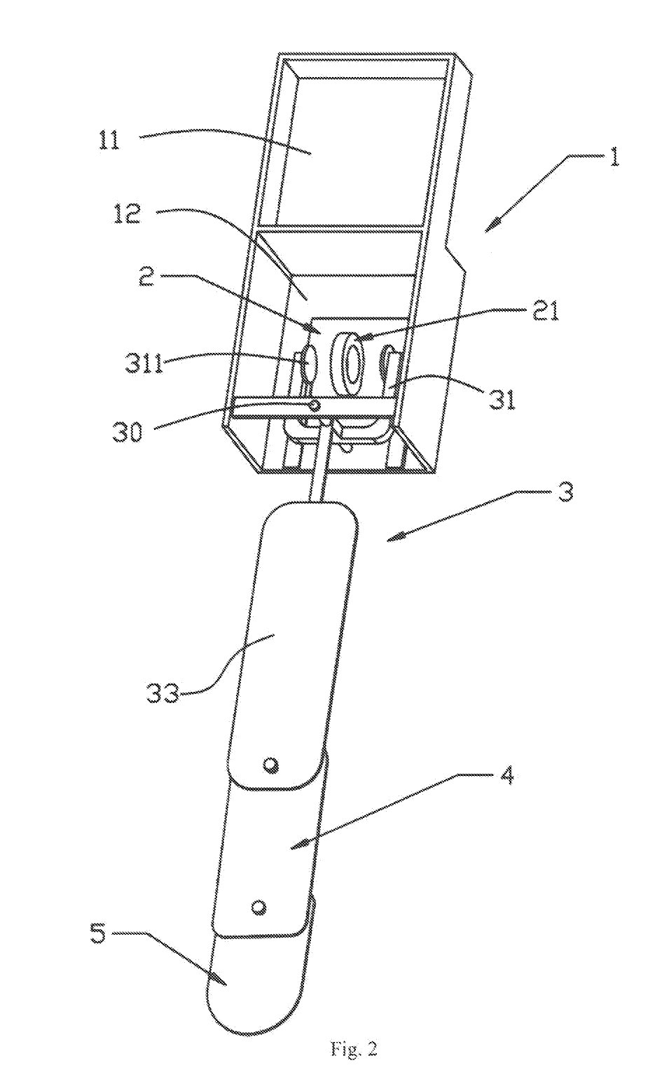

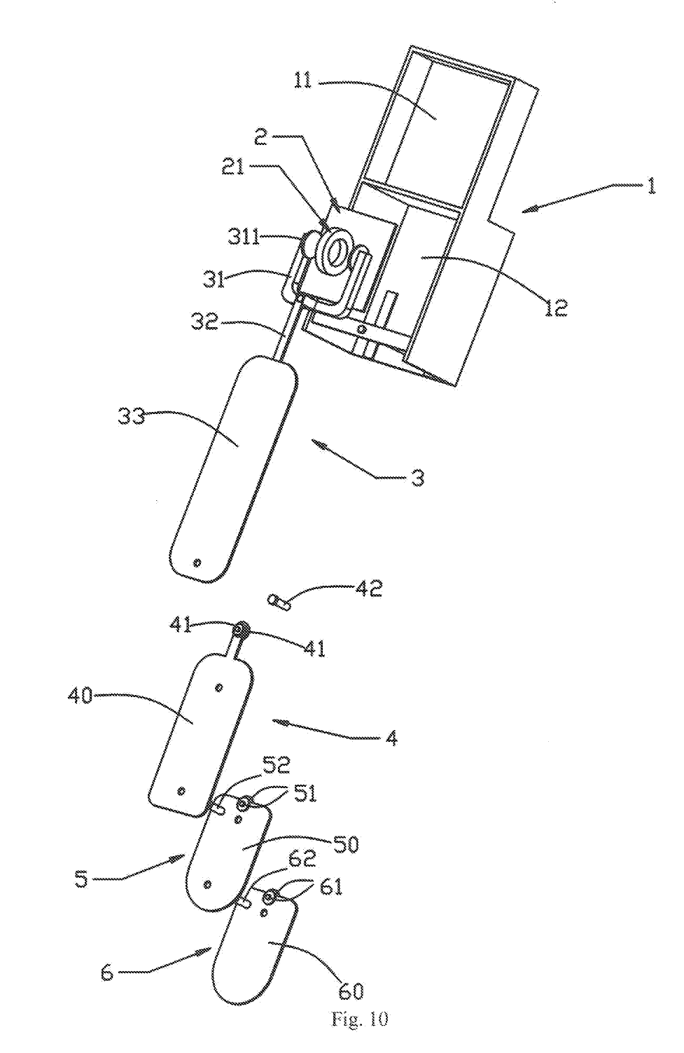

The number of swinging unit of the animal tail-wagging simulation device is not limited to the number shown in FIGS. 1 and 2. As shown in FIG. 10, a third swinging unit 6 may be provided at a lower end of the second swinging unit 5. The third swinging unit 6 may include a third swinging plate 60 pivotably coupled with the second swinging plate 50 through a fourth shaft 62, and an adjustable third counterweight member 61 provided at an upper end of the third swinging plate 60. The third counterweight member 61 may be in the form of one or more metal plates. Further swinging units may be provided at a lower end of the third swinging unit.

In the animal tail-wagging simulation device of the present application, the position where the swinging arm 3 is pivotably coupled with the housing 1 is located below the U-shaped portion 31, and the upper ends of the swinging plates are provided with adjustable counterweight members. This construction renders the center of gravity of the swinging arm and the swinging units to be situated in a suitable position, such that when the simulating animal tail swings, the entire animal tail-wagging simulation device is more lively.

Specific embodiments have been described above with reference to the accompanying drawings. However, the present application is not limited to the above specific embodiments. The above specific embodiments are merely illustrative and should not be considered as limiting. It should be noted that, upon reading the above disclosure, a person skilled in the art can make various other changes or modifications without departing from the scope of the appended claims.

What is claimed is:

1. An animal tail-wagging simulation device comprising:
a housing;
a circuit board mounted in the housing and provided with a driving coil;
a swinging arm mounted in the housing, the swinging arm being provided with a U-shaped portion at an upper end thereof, the swinging arm being pivotably coupled with the housing through a first shaft, the position where the swinging arm is pivotably coupled with the housing is located below the U-shaped portion, the driving coil being disposed in a middle of the U-shaped portion, two sides of the U-shaped portion being provided respectively with two permanent magnets that associate with the driving coil, whereby when the driving coil is energized, electromagnetic field is generated and interacts with the permanent magnets to thereby drive the swinging arm to swing;
a first swinging unit provided at a lower end of the swinging arm, the first swinging unit comprising a first swinging plate pivotably coupled with the swinging arm through a second shaft, and an adjustable first counterweight member provided at an upper end of the first swinging plate, the first counterweight member being in the form of one or more metal plates; and
a second swinging unit provided at a lower end of the first swinging unit, the second swinging unit comprising a second swinging plate pivotably coupled with the first swinging plate through a third shaft, and an adjustable second counterweight member provided at an upper end of the second swinging plate, the second counterweight member being in the form of one or more metal plates.

2. The animal tail-wagging simulation device as claimed in claim 1, wherein the first counterweight member has a weight of 7.7˜7.75 g, and the second counterweight member has weight of 1.3˜1.35 g.

3. The animal tail-wagging simulation device as claimed in claim 1, wherein a third swinging unit is provided at a lower end of the second swinging unit, the third swinging unit comprising a third swinging plate pivotably coupled with the second swinging plate through a fourth shaft, and an adjustable third counterweight member provided at an upper end of the third swinging plate, the third counterweight member being in the form of one or more metal plates.

4. An animal tail-wagging simulation device comprising:
a housing;
a circuit board mounted in the housing and provided with a driving coil;
a swinging arm mounted in the housing, the swinging arm being provided with a U-shaped portion at an upper end thereof, the swinging arm being pivotably coupled with the housing through a first shaft, the position where the swinging arm is pivotably coupled with the housing is located below the U-shaped portion, the driving coil being disposed in a middle of the U-shaped portion, two sides of the U-shaped portion being provided respectively with two permanent magnets that associate with the driving coil, whereby when the driving coil is energized, electromagnetic field is generated and interacts with the permanent magnets to thereby drive the swinging arm to swing; and
a first swinging unit provided at a lower end of the swinging arm, the first swinging unit comprising a first swinging plate pivotably coupled with the swinging arm through a second shaft, and an adjustable first counterweight member provided at an upper end of the first swinging plate.

5. The animal tail-wagging simulation device as claimed in claim 4, wherein the first counterweight member is in the form of one or more metal plates.

6. The animal tail-wagging simulation device as claimed in claim 4, wherein a second swinging unit is provided at a lower end of the first swinging unit, the second swinging unit comprising a second swinging plate pivotably coupled with the first swinging plate through a third shaft, and an adjustable second counterweight member provided at an upper end of the second swinging plate.

7. The animal tail-wagging simulation device as claimed in claim 6, wherein the second counterweight member is in the form of one or more metal plates.

8. The animal tail-wagging simulation device as claimed in claim 6, wherein the first counterweight member has a weight of 7.7˜7.75 g, and the second counterweight member has a weight of 1.3˜1.35 g.

9. The animal tail-wagging simulation device as claimed in claim 6, wherein a third swinging unit is provided at a lower end of the second swinging unit, the third swinging unit comprising a third swinging plate pivotably coupled with the second swinging plate through a fourth shaft, and an adjustable third counterweight member provided at an upper end of the third swinging plate.

10. The animal tail-wagging simulation device as claimed in claim 9, wherein the third counterweight member is in the form of one or more metal plates.
